(19) United States
(12) Patent Application Publication
(10) Pub. No.: US 2003/0204564 A1
(43) Pub. Date: Oct. 30, 2003

(54) Graphical modelling system

(76) Inventor: David Antony Keene, London (GB)

Correspondence Address: SWIDLER BERLIN SHEREFF FRIEDMAN, LLP, 3000 K STREET, NW, BOX IP, WASHINGTON, DC, 20007, US

(21) Appl. No.: 10/323,940

(22) Filed: Dec. 20, 2002

(30) Foreign Application Priority Data
Apr. 26, 2002 (GB) 0209647.7

(51) Int. Cl. G06F 15/16

(52) U.S. Cl. 709/203

(57) ABSTRACT

A distributed graphical modelling system comprises a client workstation and an application server.

The application server is associated with a store for storing graphical model data and software configured to receive messages from the client workstation.

The client workstation is adapted to execute browser software configured to interpret a tag based vector graphics language, to display vector graphics on the client workstation, and to execute user interface software. The combination of the browser software and the user interface software is configured to establish a communications link with the application server and thereby obtain graphical model data from the application server and display the graphical model data as vector graphics on the client workstation. A user interface is also established to detect and capture user input. The vector graphics displayed on the client workstation are operated upon in accordance with the user input.

### FIELD OF THE INVENTION

This invention relates to distributed application software, and in particular to a distributed graphical modelling system.

### BACKGROUND TO THE INVENTION

Conventional graphical modelling systems, for example computer aided design (CAD) and business process modelling systems are typically installed on an individual workstation. Several such workstations may be connected to a network in order that several users can access data to build the models.

The emergence of the Internet in recent years has brought about the desire to have such graphical model data made available on a central server to which several users can connect and thereby interact with the graphical model data.

Currently, there are three ways of achieving this. The first is through traditional client/server software where a computer program installed on a workstation connects directly to a database or other server or file store.

The second involves downloading the application as an applet which can be run from within the user's web browser or desktop and can hence access the graphical model data. This has the distinct disadvantage that the applet must be downloaded and will be a very large file. Indeed, this represents no advantage over installing the application permanently on the client workstation.

The third method involves downloading a hypertext markup language (HTML) description of the graphical model data, capturing user input relating to desired changes to the graphical model data, transmitting these changes to the application server where the graphical model data is updated and a new HTML page created and downloaded to the user's web browser. This has the disadvantage that there is a significant delay between capturing the user input and displaying the updated graphical model data on the user's client workstation.

### SUMMARY OF THE INVENTION

In accordance with one aspect of the present invention, there is provided a distributed graphical modelling system comprising a client workstation and an application server, wherein:

a. the application server is associated with a store for storing graphical model data and contains software configured to receive messages from the client workstation; and,

b. the client workstation is adapted to execute browser software configured to interpret a tag based vector graphics language, to display vector graphics on the client workstation, and to execute user interface software, the combination of the browser software and the user interface software being configured to:

i. establish a communications link with the application server;

ii. obtain at least a portion of the graphical model data from the application server and display the portion of the graphical model data as vector graphics on the client workstation;

iii. establish a user interface to detect and capture user input; and,.

iv. operate on the vector graphics displayed on the client workstation in accordance with the user input.

In accordance with a second aspect of the invention there is a graphical modelling method comprising:

a. using an application server to store graphical model data and to receive messages from a client workstation; and,

b. using the client workstation to interpret a tag based vector graphics language and to display vector graphics on the client workstation and to:

i. establish a communications link with the application server;

ii. obtain at least a portion of the graphical model data from the application server and display the portion of the graphical model data as vector graphics on the client workstation;

iii. establish a user interface to detect and capture user input; and,

iv. operate on the vector graphics displayed on the client workstation in accordance with the user input.

Hence, the invention provides a distributed graphical modelling system such that only a small section of user interface software has to be downloaded to the client workstation and vector graphics displayed on the client workstation are updated instantly after user input has been captured without waiting for a new HTML page to be downloaded from the application server.

The store will normally be separate from the application server. However, it may alternatively be incorporated in the application server.

Typically, the messages received by the application server are request messages transmitted by the client workstation relating to the user input.

Normally, the application server will be further configured to determine whether any particular request message is in accordance with a set of rules and:

a. if the particular request message is in accordance with the set of rules, to modify the graphical model data in accordance with the particular request message; or,

b. if the particular request message is not in accordance with the set of rules, to transmit a user interface message to the client workstation.

Typically, the client workstation will be further configured to receive vector graphics update messages from the application server and to operate on the vector graphics displayed on the client workstation in accordance with the vector graphics update messages.

Furthermore, the client workstation is typically configured to receive user interface messages from the application server and to display the user interface messages on the client workstation.

Preferably, the user interface software operates on vector graphics displayed on the client workstation using the browser software document object model (DOM).

In a preferred embodiment the graphical modelling system comprises a plurality of said client workstations such that the graphical modelling data can be accessed and modified by several users simultaneously.

The tag based vector graphics language may be based on a markup language such as extensible markup language (XML) and, in this case, the tag based vector graphics language will typically be scalable vector graphics (SVG).

Older browser software may not have the required functionality to interpret the tag based vector graphics language and to display the vector graphics on the client workstation and in this instance, the browser software is configured to interpret the tag based vector graphics language and to display vector graphics on the client workstation by a software plugin.

The user interface software may be an applet executed from within the browser software and, in this instance, the applet will typically be a Java applet.

The request messages transmitted by a client workstation to the application server are typically held in a buffer until the application server can receive them.

If the graphical modelling system comprises a plurality of client workstations then the application server may send a user interface message to a first user when the graphical model data displayed on the client workstation is modified by a second user using another client workstation.

Furthermore, the application server may send a user interface message to a first user when graphical model data related to the graphical model data displayed on the first user's client workstation is modified by a second user using another client workstation.

Typically, the application server maintains an index for each client workstation connected to it, the index containing connection data and pointers to the graphical model data displayed on the relevant client workstation. The connection data may comprise the client workstation's IP address, user connection details or work object model.

Preferably, the store for storing the graphical model data is a database.

The invention will typically be provided as a computer program comprising computer program code means adapted to perform all the steps of the second aspect of the invention when said program is run on a computer.

Further, there may be provided a computer program product comprising program code means stored on a computer readable medium for performing a method according to the second aspect of the invention when said program product is run on the computer.

### BRIEF DESCRIPTION OF THE DRAWINGS

Examples of the invention will now be described with reference to the accompanying drawings, in which:

FIG. 1 shows an arrangement of client workstations, an application server and a database;

FIG. 2 shows how the application server maintains an index for each client workstation connected to it;

FIG. 3 shows, by way of example, a vector graphics display of graphical model data representing an architectural plan;

FIG. 4 shows a vector graphics display of the graphical model data of FIG. 3 after modification;

FIG. 5 shows, by way of a further example, a vector graphics display of graphical model data representing a project plan; and,

FIG. 6 shows a vector graphics display of the graphical model data of FIG. 5 after modification.

### DESCRIPTION OF THE EMBODIMENTS

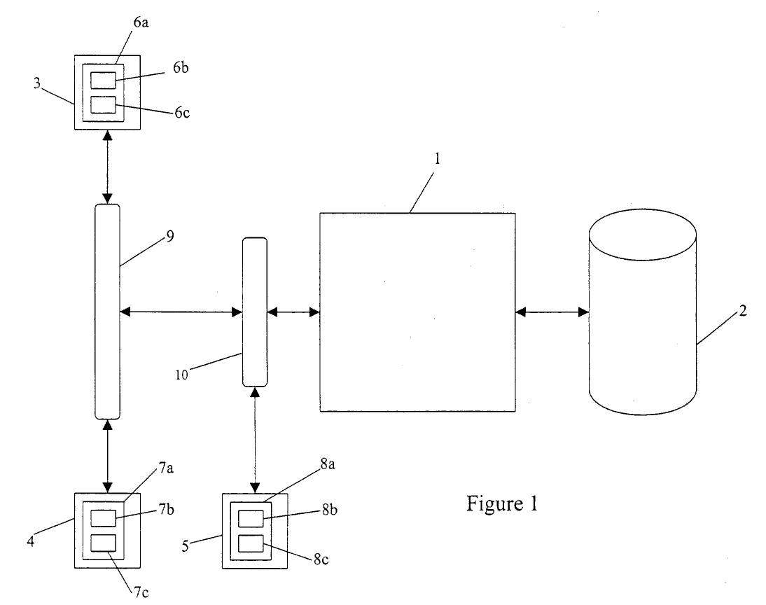

Shown in FIG. 1 are three client workstations 3,4,5 each having their own browser software 6a,7a,8a. The browser software 6a,7a,8a is configured to interpret the tag based vector graphics language scalable vector graphics (SVG) by the use of a software plug-in 6b,7b,8b. The client workstations 3,4,5 may be connected to the application server 1 using any of a variety of methods and in this instance, the client workstations 3,4 are each connected to the Internet 9 and via this to a local area network 10 to which are connected the application server 1 and the third client workstation 5.

A database 2 connected to application server 1 is used to store graphical model data. This graphical model data may relate to any of a wide variety of graphical models, such as an engineering drawing, a circuit diagram, architectural drawings or even business process drawings. The application server 1 executes software that can access the graphical model data stored in database 2 and manipulate the graphical model data in accordance with user input received from any of a plurality of client workstations 3,4,5 connected to the application server 1.

When each client workstation 3,4,5 is initially connected to the application server 1 a small Java applet 6c,7c,8c is downloaded from the application server 1 and is executed from within the browser software 6a,7a,8a located on each client workstation 3,4,5.

The Java applet 6c,7c,8c establishes a user interface to detect and capture the user's input. Initially, for example, a user will wish to download at least a portion of the graphical model data stored on database 2 such that it can be viewed on the client workstation 3,4 or 5 where he is located. In order to do this, the user selects the portion of the graphical model data that he wishes to download and a corresponding request message is sent from the client workstation 3,4 or 5 where he is located to the application server 1. The application server 1 then retrieves the requested graphical model data from the database 2 and transmits an SVG description of the graphical model data back to the client workstation 3,4 or 5 where he is located. On receipt of this SVG description the browser software 6a,7a or 8a enabled by the SVG plug-in 6b,7b or 8b interprets the SVG description and displays the corresponding vector graphics on the client workstation 3,4 or 5.

The Java applet 6c,7c,8c and the SVG environment can then detect and capture user input relating to changes to the vector graphics displayed on the client workstation 3,4,5 required by the user. These changes may affect any of the attributes of an element of the vector graphics. For example, the size, shape, position and colour of an element may be modified. Furthermore, new elements may be created.

In a trivial example, the client workstation 3 may be displaying a red rectangle and the user wishes to change its colour to blue. To do this he would enter the command to change it to blue and this would be captured by Java applet 6c. The rectangle would then be turned blue by the Java applet 6c and a request message placed in a buffer for onward transmission to application server 1.

On receipt of the request message, the application server 1 determines whether the request message is in accordance with a set of rules. These rules will be application specific but, for example, the application server 1 may confirm that the user has the required privileges to make the requested change.

If he does then the application server 1 can amend the appropriate record on database 2 and then send user interface messages to other client workstations where the element is being displayed advising those users of the change and asking if they would like the vector graphics displayed on their client workstations to be updated. A vector graphics update message can then be sent to those client workstations as an SVG description which can be interpreted by the browser software and used to update the vector graphics.

If he does not have the required privileges then the application server 1 can send a user interface message advising him of this to client workstation 3 followed by a vector graphics update message as an SVG description to cause the rectangle to turn red again.

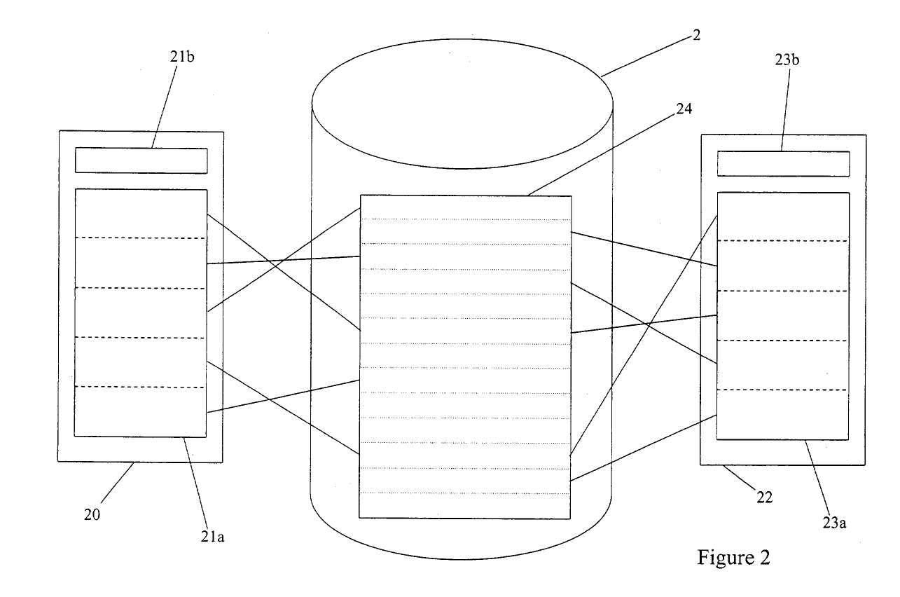

If the software executing on the application server 1 were to create a new instance of the graphical model data stored on database 2 for each user connected to the application server 1 then this would be extremely wasteful in terms of storage requirements. Hence, as depicted in FIG. 2, the software executing on the application server 1 maintains an index 20,22 for each user connected to it. Each index 20,22 comprises connection data 21b,23b which contains information relating to the communications channel via which each respective client workstation is connected to the application server 1. This may include data such as the IP address of the client workstation and the timeout status of the connection. The indices 20,22 further comprise a list of graphical object identification codes 21a,23a which reference the graphical objects 24 stored in database 2 having the same identification code. As such, the data stored by the application server 1 to allow each client workstation to access and manipulate the graphical model data stored on database 2 is minimal in size. This allows a large number of users to connect to the application server 1 before its storage capacity is fully utilised.

Two illustrative examples of how the invention is used in practice will now be given. In the first example, the graphical model data stored on database 2 represents the architectural drawings of a house. In this example, the first user situated at client workstation 3 is responsible for the structural design of the house, the second user situated at client workstation 4 is responsible for the interior design including the design of the bathroom and the third user situated at the client workstation 5 is responsible for the design of the plumbing.

Initially, the interior designer causes his client workstation 4 to be connected to the application server 1 using browser software 2a. The application server 1 transmits applet 7c to client workstation 4 where it is executed by the browser software 7a. The interior designer can now request a portion of the graphical model data in which he is interested from the application server 1.

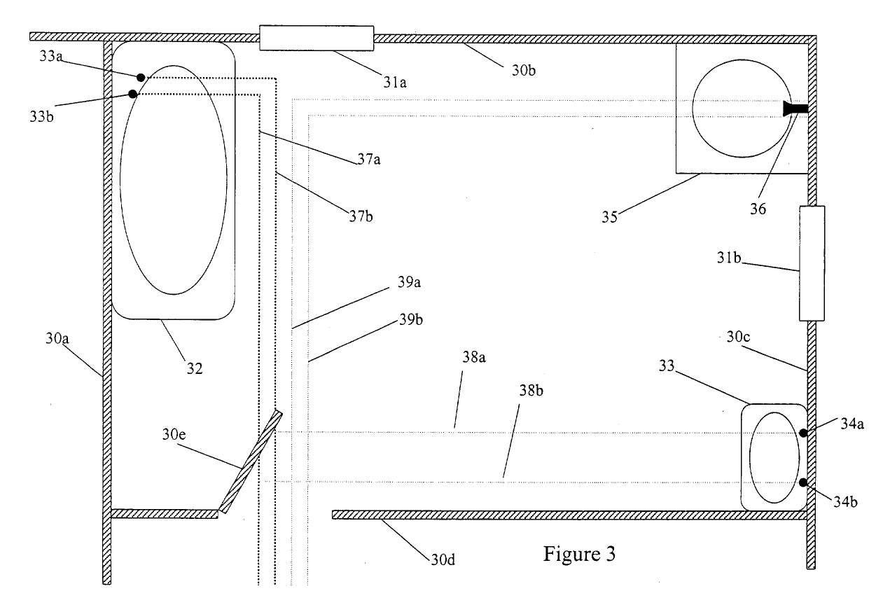

The application server 1 retrieves the related graphical model data from the database 2 and constructs from this an SVG description which is transmitted to client workstation 4. The SVG description is then interpreted by browser software 7a with SVG plugin 7b such that the diagramatic representation of the bathroom as shown in FIG. 3 can be recreated on client workstation 4.

In this plan view, there are four walls 30a,30b,30c and 30d, a door 30e and two windows 31a,31b defining the periphery of the bathroom. Within the bathroom, there is a bath 32 having hot and cold water taps 33a,33b, a sink 33 having hot and cold water taps 34a,34b and a shower 35 having a shower head 36. Also shown in FIG. 3 is the layout of the plumbing in which pipes 37a,37b supply hot and cold water taps 33a,33b, pipes 38a,38b supply hot and cold water taps 34a,34b and pipes 39a,39b supply hot and cold water to shower head 36.

Each of the elements shown in FIG. 3 are stored on database 2 as a graphical object record. This record comprises a graphical object identification code, geometrical data for the object such as shape, size and position along with other attributes such as colour, material and dependency data. The dependency data identifies other objects which may be affected by a change to the present object. Thus, if bath 32 is moved the software executing on application server 1 can take appropriate action with regard to the dependent elements, in this case hot and cold water taps 33a,33b. Furthermore, the graphical object record may contain attributes for more than one shape.

For example, the graphical object record for bath 32 comprises attributes defining the object identification code, the shape, size and position of the boundary rectangle and also the centrally positioned oval along with attributes indicating that hot and cold water taps 33a,33b are dependent on bath 32.

In the event of a change in the specification, the interior designer may, for example, require to add a new counter 40 and a new sink 41 with associated hot and cold water taps 43a,43b and water supply pipework 42a,42b. The interior designer can do this using, for example, mouse or keyboard entry of commands which are captured by the user interface applet 7c.

In this example, due to the introduction of counter 40 and sink 41, the interior designer must move bath 32 and associated hot and cold water taps 33a,33b to the opposite corner of the room which means that shower 35 and shower head 36 have similarly had to be moved to an alternate corner of the room.

These changes will be reflected instantly on the client workstation 4 where the user interface applet 7c modifies the vector graphics displayed on client workstation 4 via the browser software's 7a document object model (DOM). The DOM provides a hierarchical description of the vector graphics displayed by the browser software 7a along with a set of software routines for modifying the vector graphics.

The user interface applet 7c also creates request messages relating to the creation of graphical objects for the counter 40, sink 41 and associated hot and cold water taps 43a,43b, the movement of sink 33 and associated hot and cold water taps 34a,34b, the movement of bath 32 and associated hot and cold water taps 33a,33b and the movement of shower 35 and associated shower head 36. These request messages are placed in a buffer for onward transmission to application server 1.

On receipt of these request messages the software executing on application server 1 can create the new graphical object data relating to counter 40 and sink 41 and associated hot and cold water taps 43a,43b. It can also alter the graphical model data for those items which have been moved in accordance with the relevant request messages. At this point, since bath 32 has been moved such that it coincides with window 31b, the software executing on application server 1 can respond in one of two ways:

a. if the window is immovable, it can send a user interface message to client workstation 4 which will be displayed and indicate to the interior designer that he is unable to move bath 32 to this position.

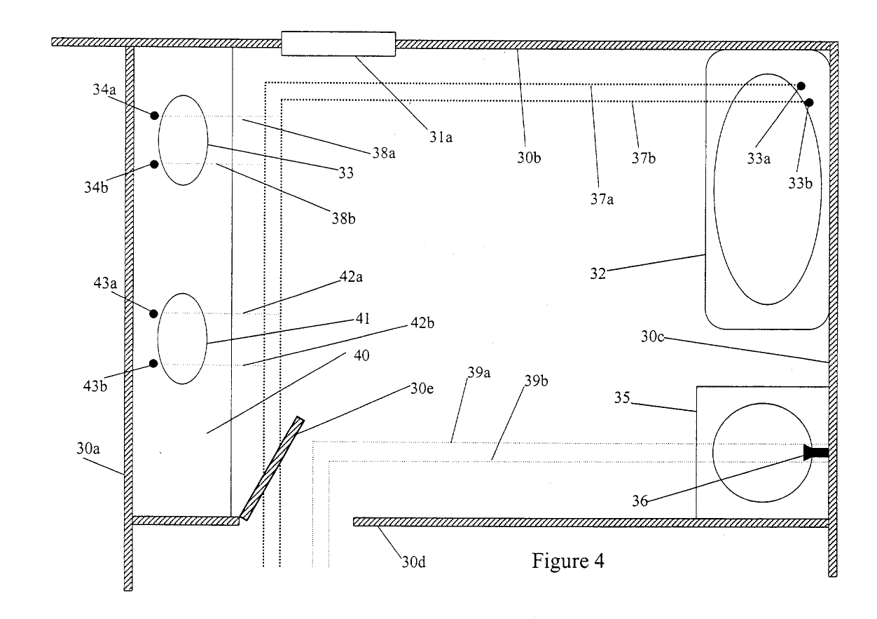

b. if the window is movable, it can send a user interface message to client workstation 3 where the structural designer is located informing him of this problem. As can be seen from FIG. 4, in this example the structural designer has chosen to remove window 31b. Furthermore, user interface messages can be sent to client workstation 5 where the plumbing designer is located informing him that taps 33a,33b,34a,34b and shower head 36, all of which are dependent on pipes 37a,37b,38a,38b,39a,39b have been moved. Additionally, it may send a user interface message to client workstation 5 advising him that new taps 43a,43b have been created which have a dependency attribute for which no objects exist. From this information, he can rearrange the layout of pipes 37a,37b,38a,38b,39a,39b and create new pipes 42a,42b as shown in FIG. 4.

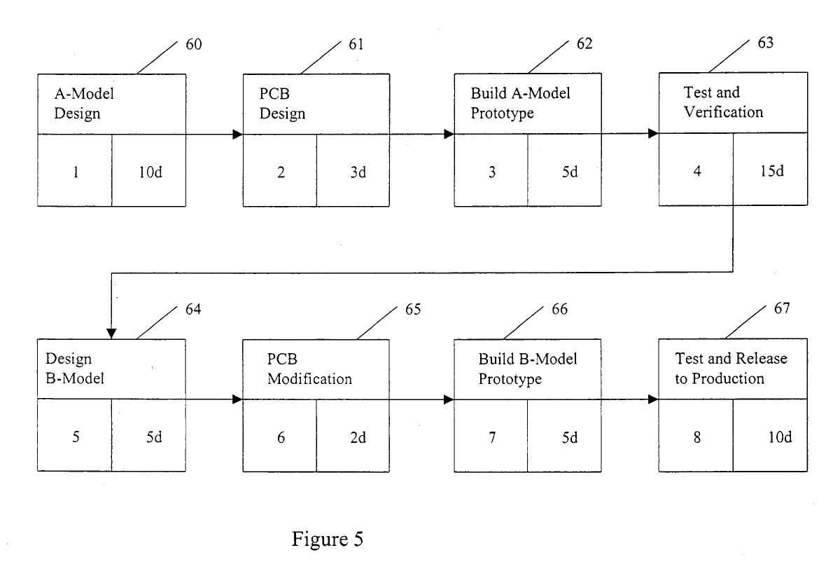

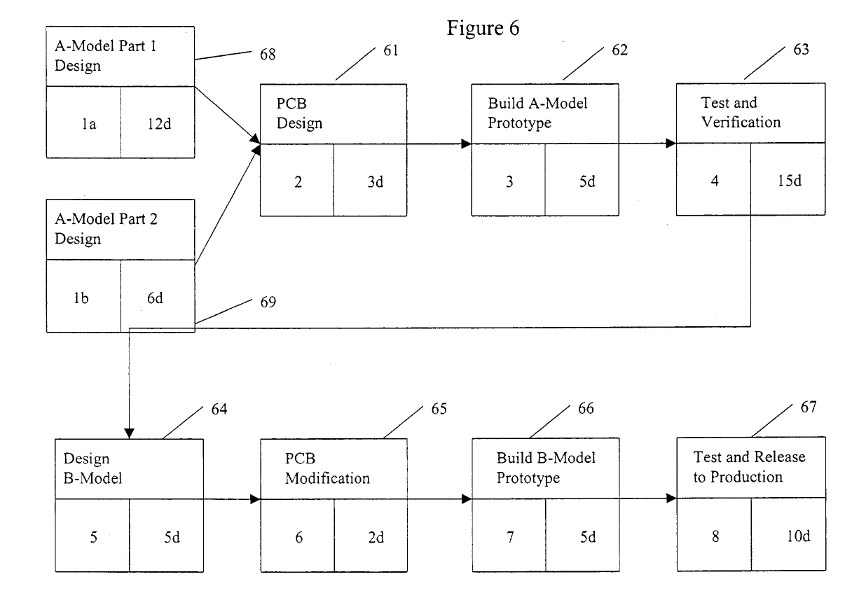

A further example of the invention is illustrated in FIGS. 5 and 6. In this embodiment, the software executing on the application server 1 and the applet user interface software 6c,7c,8c is adapted to be used as project management software. FIG. 6 shows a simple project plan as may be used in the design and testing of an electronic product. Each of the nodes 60 to 67 in this plan represents a significant stage in the project. All the nodes 60 to 67 are split into three rectangles, the top rectangle indicating the name of the task, the bottom left rectangle indicating the identification code for the task and the bottom right rectangle indicating the duration of the task. For example, node 60 refers to the “A model design” task and has an identification code of “1”. The task lasts for ten days. Node 61 depends on node 60 as indicated by the arrow joining them and this means that the task represented by node 61 cannot commence until the task represented by node 60 has been finished.

Database 2 stores a graphical object representation of the nodes having attributes defining the size and position of the rectangles along with the identification code, the task title and the task duration. The graphical object model data will also indicate the dependencies, for example that node 61 represented by identification code 2 depends on node 60 represented by identification code 1.

If a new feature is introduced into the design specification of the electronic product then it may be that the length of time required to complete the A-model design is extended to fifteen days. The designer situated at client workstation 3 can, using user interface applet 6c, amend the duration of this task and the vector graphics displayed on client workstation 3 will be updated immediately by user interface applet 6c via the browser software's 6a DOM. A request message will be placed in the buffer and hence, sent via the Internet 9 and local area network 10 to application server 1. The software executing on application server 1 will determine that nodes 61 to 67 are dependent on node 60 and then send user interface messages to relevant people, one of whom is the printed circuit board (PCB) designer situated at client workstation 4 and another who is the project manager situated at client workstation 5.

Clearly the introduction of this feature will mean that the work on the PCB design cannot be commenced until fifteen days have elapsed and it may be that the PCB designer is already committed to work on another project at the time. To resolve this problem the project manager can divide the A-model design task into two parts by adding new nodes 68,69 using user interface applet 8c as shown in FIG. 7. As can be seen the PCB design task represented by node 61 now depends on the “A-Model Part One Design” and the “A-Model Part Two Design” the durations of which are twelve and six days respectively. As such, the PCB design task can be completed before the PCB designer must start work on the other project to which he is committed and the project can be completed as required. Vector graphics update messages in the form of SVG descriptions can be sent from application server 1 to client workstations 3,4 such that browser software 6a,7a enabled by plug-in software 6b,7b can update the vector graphics displayed on client workstations 3,4 appropriately.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of a particular type of signal bearing media actually used to carry out the distribution. Examples of computer readable media include recordable-type media such as floppy disk, a hard disk drive, RAM and CDROMS as will as transmission-type media, such as digital and analogue communications links.

We claim:

1. A distributed graphical modelling system comprising a client workstation and an application server, wherein:
a. the application server is associated with a store for storing graphical model data and software configured to receive messages from the client workstation; and,
b. the client workstation is adapted to execute browser software configured to interpret a tag based vector graphics language, to display vector graphics on the client workstation, and to execute user interface software, the combination of the browser software and the user interface software being configured to:
i. establish a communications link with the application server;
ii. obtain at least a portion of the graphical model data from the application server and display the portion of the graphical model data as vector graphics on the client workstation;
iii. establish a user interface to detect and capture user input; and,
iv. operate on the vector graphics displayed on the client workstation in accordance with the user input.

2. A distributed graphical modelling system according to claim 1, wherein the store is separate from the application server.

3. A distributed graphical modelling system according to claim 1, wherein the store is incorporated in the application server.

4. A distributed graphical modelling system according to claim 1, wherein the messages received by the application server are request messages transmitted by the client workstation relating to the user input.

5. A distributed graphical modelling system according to claim 1, wherein the application server is further configured to determine whether any particular request message is in accordance with a set of rules and:
a. if the particular request message is in accordance with the set of rules, to modify the graphical model data in accordance with the particular request message; or,
b. if the particular request message is not in accordance with the set of rules, to transmit a user interface message to the client workstation.

6. A distributed graphical modelling system according to claim 1, wherein the client workstation is further configured to receive vector graphics update messages from the application server and to operate on the vector graphics displayed on the client workstation in accordance with the vector graphics update messages.

7. A distributed graphical modelling system according to claim 1, wherein the client workstation is further configured to receive user interface messages from the application server and to display the user interface messages on the client workstation.

8. A distributed graphical modelling system according to claim 1, wherein the user interface software operates on the vector graphics displayed on the client workstation using the browser software's document object model.

9. A distributed graphical modelling system according to claim 1, further comprising a plurality of said client workstations.

10. A distributed graphical modelling system according to claim 1, wherein the tag based vector graphics language is based on a markup language such as extensible markup language (XML).

11. A distributed graphical modelling system according to claim 10, wherein the tag based vector graphics language is Scalable Vector Graphics (SVG).

12. A distributed graphical modelling system according to claim 1, wherein the browser software is configured to interpret the tag based vector graphics language and to display vector graphics on the client workstation by a software plug-in.

13. A distributed graphical modelling system according to claim 1, wherein the user interface software is an applet executed from within the browser software.

14. A distributed graphical modelling system according to claim 13, wherein the applet is a Java applet.

15. A distributed graphical modelling system according to claim 1, wherein the request messages transmitted by the client workstation to the application server are held in a buffer until the application server can receive them.

16. A distributed graphical modelling system according to claim 9, wherein the application server sends a user interface message to a first user when the graphical model data displayed on their client workstation is modified by a second user using another client workstation.

17. A distributed graphical modelling system according to claim 9, wherein the application server sends a user interface message to a first user when graphical model data related to the graphical model data displayed on the first user's client workstation is modified by a second user using another client workstation.

18. A distributed graphical modelling system according to claim 1, wherein the application server maintains an index for each client workstation connected to it, the index containing connection data and pointers to the graphical model data displayed on the relevant client workstation.

19. A distributed graphical modelling system according to claim 18, wherein the connection data comprises the client workstation's IP address, user connector details or work object model.

20. A distributed graphical modelling system according to claim 1, wherein the store for storing the graphical model data is a database.

21. A graphical modelling method comprising:
a. using an application server to store graphical model data and to receive messages from a client workstation; and,
b. using the client workstation to interpret a tag based vector graphics language and to display vector graphics on the client workstation and to:
i. establish a communications link with the application server;
ii. obtain at least a portion of the graphical model data from the application server and display the portion of the graphical model data as vector graphics on the client workstation;
iii. establish a user interface to detect and capture user input; and,
iv. operate on the vector graphics displayed on the client workstation in accordance with the user input.

22. A graphical modelling method according to claim 21, wherein the application server receives request messages transmitted by the client workstation relating to the user input.

23. A graphical modelling method according to claim 21, wherein the application server determines whether the request message is in accordance with a set of rules and:
a. if the request message is in accordance with the set of rules, modifies the graphical model data in accordance with the request message; or,
b. if the request message is not in accordance with the set of rules, transmits a user interface message to the client workstation.

24. A graphical modelling method according to claim 21, wherein the client workstation receives vector graphics update messages from the application server and operates on the vector graphics displayed on the client workstation in accordance with the vector graphics update messages.

25. A graphical modelling method according to claim 21, wherein the client workstation receives user interface messages from the application server and displays the user interface messages on the client workstation.

26. A graphical modelling method according to claim 21, further comprising holding the request messages in a buffer on the client workstation until the application server can receive them.

27. A graphical modelling method according to claim 21, wherein the graphical model data is stored on a database.

28. A computer program comprising computer program code means adapted to perform all the steps of claim 21 when said program is run on a computer.

29. A computer program product comprising program code means stored on a computer readable medium for performing the method of claim 21 when said program product is run on a computer.
